(19) United States
(12) Patent Application Publication
(10) Pub. No.: US 2020/0100522 A1
(43) Pub. Date: Apr. 2, 2020

(54) APPARATUS AND METHODS FOR PREPARING A CHOCOLATE BOTTLE CASING

(71) Applicants: Theresa KERSTEIN, Willowbrook, IL (US); Andrew KERSTEIN, Willowbrook, IL (US); Karyn DOWNEY, Stickney, IL (US)

(72) Inventors: Theresa KERSTEIN, Willowbrook, IL (US); Andrew KERSTEIN, Willowbrook, IL (US); Karyn DOWNEY, Stickney, IL (US)

(21) Appl. No.: 16/585,026

(22) Filed: Sep. 27, 2019

Related U.S. Application Data
(60) Provisional application No. 62/738,175, filed on Sep. 28, 2018.

(51) Int. Cl. A23G 1/54; A23G 3/34

(52) U.S. Cl. CPC A23G 1/545; A23G 3/0038; A23G 3/0029

(57) ABSTRACT

The present invention provides an apparatus and method for preparing edible bottle casings that allow for efficient and standardized fabrication, and customization, thereof.

### CROSS REFERENCE TO RELATED APPLICATIONS

The present application is related to and claims the benefit under 35 U.S.C. § 119(e) of U.S. Provisional Patent Application No. 62/738,175, filed Sep. 28, 2018, which is expressly incorporated fully herein by reference.

### FIELD OF THE INVENTION

The present invention relates generally to an apparatus and methods for preparing a chocolate bottle casing which allow for the efficient and standardized preparation of such casings.

### BACKGROUND

Bottles, such as wine and liquor bottles, are often sold with decorative or unique labels or markings to help identify the brand or type of alcohol. Often, these labels are distinctive and so have the dual purposes of identifying the manufacturer and causing the bottle to stand out amongst numerous other bottles of similar shape and size.

It is well known that there also exist vendors who sell customizable bottle labels. These labels typically come in the form of a “sticker” or “sleeve” that can be wrapped around the existing manufacturer label on the bottle. These customizable bottle labels are often prepared with an individual message for the recipient of the bottle (e.g., “Congratulations Jim!” “Happy Birthday Mom!” etc.).

The existing bottle labels and customizable label options fail to take into account that often these celebratory bottles are exchanged or presented to a recipient during the course of, or in anticipation of, a meal (or in other contexts where food is being consumed). Current techniques for edible bottle labels, however, are also limited. Typically, the customer must first procure the bottle and physically present it to a vendor (e.g., a chocolatier). Then, in order to prepare a chocolate covered wine bottle, the lower portion of a bottle is wrapped in a food-safe barrier layer (such as, for example, cellophane or wax paper). Chocolate is then layered onto the barrier layer, and decorations are added only once the chocolate is on the bottle.

This process is time-consuming and requires the customer to take numerous steps and then endure a waiting period, making it less than ideal for unexpected, spontaneous, or last-minute occasions. Further, the process of adding decorations to the chocolate only after the chocolate is on the bottle complicates the decoration process and can limit decoration options.

There also exist chocolate molds in the shape of a bottle, but these are not usable for preparing a casing for an actual bottles.

Accordingly, it would be desirable to have an apparatus and methods for preparing edible bottle casings that would allow for efficient and standardized prefabrication, as well as easier customization, of these casings.

### SUMMARY OF THE INVENTION

The present invention comprises a casing mold apparatus for preparing a bottle casing, the apparatus comprising a first half-cylindrical mold and a second half cylindrical mold, each comprising a half-base, half open top, a left wing, and a right wing, wherein the first half-cylindrical mold and a second half cylindrical mold are joined together with a fastening means.

In one embodiment, the present invention comprises a casing mold apparatus used to prepare a chocolate bottle casing.

In a separate aspect, the present invention comprises a casing mold apparatus used to prepare a chocolate bottle casing for use with a wine bottle.

In a further embodiment, the present invention comprises tempered chocolate comprising one or more of the following: milk chocolate, dark chocolate, and white chocolate.

In a further embodiment, the present invention comprises chocolate further comprising one or more of cookies or cookie pieces, candies, coconut, crisped rice, sprinkles, fruits, nuts, edible printed paper, edible glitter, icing decorations, small molded chocolate pieces, and/or sugar pieces.

In a separate aspect, the present invention comprises a chocolate bottle casing customized using edible materials.

In a separate aspect, the present invention comprises a chocolate bottle casing about 0.25 inches thick.

In a separate aspect, the present invention comprises a chocolate bottle casing about 0.5 inches thick.

In a separate aspect, the present invention comprises a chocolate bottle casing about 0.75 inches thick.

In a further embodiment, the present invention comprises fastening means comprising one or more clips.

In a further embodiment, the present invention comprises two half-cylindrical molds made of at least one of the following: plastic or silicone.

In a further embodiment, the present invention comprises a solid cylindrical core between the first half-cylindrical mold and a second half cylindrical mold.

In a further embodiment, the present invention comprises the solid cylindrical core permanently affixed to the half-base of one or both of the first and a second half cylindrical molds.

In one embodiment, the present invention comprises a method for manufacturing a chocolate bottle casing, the method comprising securing two half-cylindrical molds to each other to form a casing mold apparatus; pouring chocolate into the casing mold apparatus; separating the two half-cylindrical molds; and extracting the chocolate bottle casing.

In a further embodiment, the present invention comprises inserting a solid cylindrical core into the casing mold apparatus prior to pouring the chocolate.

In a further embodiment, the present invention comprises inserting a bottle into the extracted chocolate bottle casing.

In a further embodiment, the present invention comprises a wine bottle.

In a further embodiment, the present invention comprises customizing the exterior of the chocolate bottle casing.

In a further embodiment, the present invention comprises customizing the exterior of the chocolate bottle casing using edible materials.

In a further embodiment, the present invention comprises customizing the exterior of the chocolate bottle casing is customized with text.

### BRIEF DESCRIPTION OF THE DRAWINGS

FIG. 1 illustrates a casing mold apparatus with two half-cylindrical units joined together in accordance with embodiments of the invention.

FIG. 2 illustrates a casing mold apparatus with two half-cylindrical units separated in accordance with embodiments of the invention.

FIG. 3 illustrates a side view of a casing mold apparatus in accordance with embodiments of the invention.

FIG. 4 illustrates an overhead view of a casing mold apparatus including two half-cylindrical units joined together in accordance with embodiments of the invention.

FIG. 5 illustrates two wine bottles with decorated chocolate bottle casings prepared in accordance with embodiments of the invention.

### DETAILED DESCRIPTION OF THE INVENTION

Embodiments of the invention comprise a chocolate bottle casing for one or more of the neck, body, or bottom of a bottle. The chocolate bottle casing may be used for bottles of alcohol (including, e.g., wine, liquor, etc.), but may also be used for non-alcoholic beverages served in similar containers (e.g., sparkling cider), as well as any other type of suitable bottle. Embodiments of the invention further include individualized bottle casings for other types of commercially sold bottles not specifically described herein. Embodiments of the invention may further include bottles with non-liquid contents.

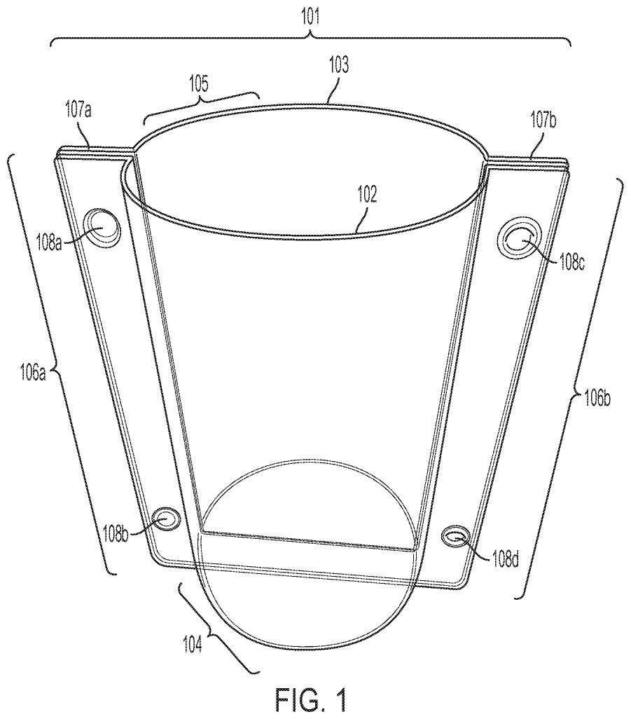

In embodiments of the invention, a chocolate bottle casing may be prepared as shown in FIG. 1. FIG. 1 illustrates a casing mold apparatus (101) used in preparation of bottle casings in accordance with the present invention. In embodiments of the invention, casing mold apparatus (101) is made of plastic. However, those skilled in the art will appreciate that the casing mold apparatus (101) could be made using any material with comparable or similar properties and integrity, as well as any other suitable material known in the art. Casing mold apparatus (101) may comprise two half-cylindrical units, a first half-cylindrical unit (102) and a second half-cylindrical unit (103). When joined together, the first half-cylindrical unit (102) and second half-cylindrical unit (103) form a circular base (104) and an open top (105). The first and second half-cylindrical units (102, 103) may be secured to each other with a fastening means (such as, e.g., clips, pins, or any fastener) in order to hold the two half-cylindrical pieces into a one-piece arrangement.

In an embodiment of the invention, each half cylindrical piece may have a left wing and a right wing. For example, in FIG. 1, the first half-cylindrical unit (102) has left wing (106a) and right wing (106b). The second half-cylindrical unit (103) has left wing (107a) and right wing (107b). These wings can be used as a place on which to affix a fastening means. In an embodiment of the invention depicted in FIG. 1, the left wings (106a, 107a) and right wings (106b, 107b) when joined together each bear two aligned fastener holes (108a, 108b, 108c, 108d). In embodiments of the invention, fastener holes (108a, 108b, 108c, 108d) may be secured with a fastening means. However, this embodiment is only intended to be exemplary, and the first half-cylindrical unit (102) and a second half-cylindrical unit (103) may be secured together in any suitable manner.

If used to prepare a casing for a standard wine bottle, the length of the casing mold—measured from circular base (104) to top (105)—may, in embodiments of the invention, be about 7″ tall. The diameter of a standard wine bottle is about 3.5″ at the top of the bottle (i.e., the end closest to the bottle neck). Thus, in embodiments of the invention, the open top (105) of the casing mold apparatus (101) may also be about 3.5″ in diameter. It is notable that the diameter of certain bottles may be consistent (i.e., having the same diameter at both the end closest to, and furthest, from the bottle neck). In such circumstances, base (104) of the casing mold apparatus (101) may also be about 3.5″. In some instances, however, the diameter of the bottle base may be larger at the bottom (the end furthest from the bottle neck), such as, e.g., about 4.0″. In such circumstances, base (104) of the casing mold apparatus (101) may then be about 4.0″ in diameter. In the examples above, it may be desirable for a particular bottle casing mold to provide for additional circumference (such as, for example, about ¼″) at the base (104) and/or open top (105) of the casing mold apparatus (101) in order to account for the thickness of the chocolate and to generate an optimally fitted chocolate bottle casing.

Embodiments of the invention allow for and include casing mold apparatuses of varying sizes depending on the bottle they are designed to fit. For example, in an embodiment of the invention, a mold may be prepared for a “mini-bottle” of liquor. In such an embodiment, the diameter of the base (104) would be about 1.5″, and the casing mold apparatus (101) would measure about 2″-3″ in length (measured from circular base (104) to top (105)).

It may be desirable for casing mold apparatus (101) to be usable to prepare casings for a variety of different sizes of bottles. Therefore, in embodiments of the invention, casing mold apparatus (101) may be expandable or adjustable in order to fit different sizes and/or types of bottles. This may be accomplished in any suitable manner. For instance, in embodiments of the invention, a filler piece may be inserted between the first half-cylindrical unit (102) and a second half-cylindrical unit (103) that allows for casing mold apparatuses of varying sizes to be prepared. In another illustrative example, the fastening means may allow for different measurements of the casing mold apparatus based on where and how the wings are fastened. In embodiments of the invention, there may be a mechanism for adjusting the size of base (104) and/or open top (105) to the desired measurements.

In embodiments of the invention, it may be desirable to make any other dimension of casing mold apparatus (101) adjustable or expandable, such as, for instance length (the distance from circular base (104) to top (105)); the dimensions of left wings (106a, 107a) and right wings (106b, 107b); the diameter of the fastener holes (108a, 108b, 108c, 108d); as well as any other dimensions and/or features of the casing mold apparatus (101). In embodiments of the invention, the casing mold apparatus itself will be marked to indicate the different measurements to which the casing mold apparatus may be adjusted, in order to efficiently facilitate fitting different bottle types and/or bottle sizes. Additionally or alternatively, the casing mold apparatus may be expandable or adjustable in order to accommodate differing thicknesses of the chocolate casing. Those skilled in the art will appreciate that the manner in which the casing mold apparatus of the present invention may be made expandable or adjustable is not limited to the specific embodiments described herein.

Further, the left wings (106a, 107a) and right wings (106b, 107b) on each of the first half-cylindrical unit (102) and a second half-cylindrical unit (103) need not be limited to the specific configuration shown and described in FIG. 1. Indeed, those skilled in the art will appreciate that left wings (106a, 107a) and right wings (106b, 107b) may be in any shape, position, or orientation that will facilitate the joinder of the first half-cylindrical unit (102) and a second half-cylindrical unit (103). Similarly, the fastener holes (108a, 108b, 108c, 108d) shown and described in FIG. 1 may be in any shape, position, or orientation that will facilitate the joinder of the first half-cylindrical unit (102) and a second half-cylindrical unit (103). Those skilled in the art will appreciate that embodiments of the invention may facilitate the joinder of the first half-cylindrical unit (102) and a second half-cylindrical unit (103) without the use of wings and/or fastener holes.

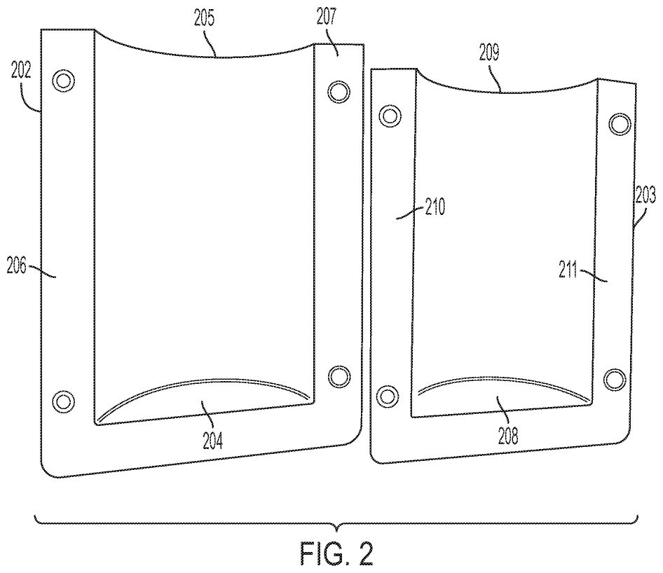

FIG. 2 illustrates an embodiment of the invention in which the first half-cylindrical unit (202) and a second half-cylindrical unit (203) are separate units, before or after being joined together to form a one-piece casing mold apparatus. The first half-cylindrical unit (202) has a half base (204), half open top (205), and a left wing (206) and right wing (207). Similarly, the second half-cylindrical unit (203) has the corresponding other half base (208), half open top (209), left wing (210) and right wing (211).

When the first half-cylindrical unit (202) and a second half-cylindrical unit (203) are oriented and joined together to form a one-piece casing mold apparatus, the left wing (206) on the first half-cylindrical unit (202) is aligned with the right wing (211) on the second cylindrical unit (203). Similarly, the right wing (207) on the first half-cylindrical unit (202) is aligned with the left wing (210) on the second cylindrical unit (203). If the second half-cylindrical unit (203) is oriented and joined to the first half-cylindrical unit (202), and a the alignment of the left wing (206) on the first half-cylindrical unit (202) with the right wing (211) on the second cylindrical unit (203) will form the left wing of the one-piece casing mold apparatus. Similarly, the alignment of the right wing (207) on the first half-cylindrical unit (202) with the left wing (210) on the second cylindrical unit (203) will form the right wing of the one-piece casing mold apparatus.

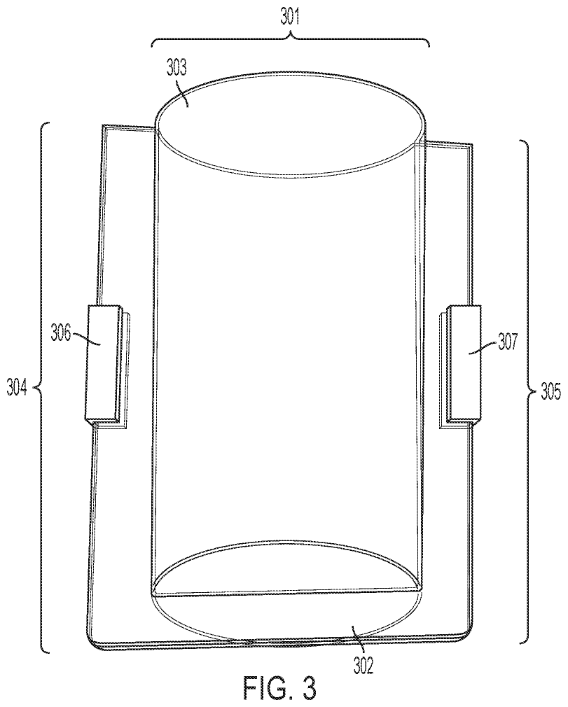

FIG. 3 illustrates another view of an embodiment of the invention which includes the two half-cylindrical units combined together into a one-piece casing mold apparatus (301), with base (302), open top (303), left wing (304) and right wing (305). Left wing (304) holds the two half-cylindrical units together with fastener (306), and likewise, right wing (305) holds the two half-cylindrical units together with fastener (307). While FIG. 3 illustrates this particular arrangement of the left wing, right wing, those skilled in the art will appreciate that any arrangement thereof which facilitates the joinder of the two cylindrical units would be acceptable.

Once the two half-cylindrical molds have been secured to each other to form a one piece casing mold, the chocolate of choice may be tempered to the appropriate temperature and poured into the one-piece casing mold. Those skilled in the art will appreciate that chocolate may be poured into the mold in any manner known in the art, including but not limited to spooning the chocolate into the mold.

Notably, although the present disclosure refers to “chocolate,” this may include milk chocolate, dark chocolate, white chocolate, or any other chocolates known in the art as well as any combination or mixture of such chocolates. Still further, “chocolate” may also refer to a combination of any of the foregoing chocolates with other ingredients, such as cookies or cookie pieces, candies, coconut, crisped rice, sprinkles, fruits, nuts, edible printed paper, edible glitter, icing decorations, small molded chocolate pieces, sugar pieces, and/or any other similar or suitable ingredient.

Depending on the amount of chocolate poured into the one-piece casing mold, the pouring process may result in a chocolate bottle casing with varying levels of thickness. The chocolate casing may be of any thickness desired. It should be noted, however, that chocolate casing of insufficient thickness may be unable to sustain the customization and/or decoration as described herein. Further, a chocolate casing that is too thick may present fit issues once the bottle is inserted into the casing. Accordingly, in embodiments of the invention, the thickness of the chocolate casing will be about 0.25″ thick. In embodiments of the invention, the chocolate casing may be about 0.125″ or 0.25″ thick, or of any suitable thickness in between, depending on the desired aesthetic and thickness of the chocolate bottle casing. Again, however, depending on the type of bottle or design desired, the thickness may be greater or less than the specific embodiments described herein. Additionally or alternatively, in embodiments of the invention, the diameter of the solid cylindrical core may be adjusted to correspond with the amount and thickness of chocolate desired for the particular casing being prepared.

In embodiments of the invention, the tempered chocolate may simply be poured into the mold in such a manner as to increase the likelihood that the tempered chocolate will adhere to the sides of the casing mold apparatus. Additionally or alternatively, the casing mold apparatus may comprise a hole or opening at the base which allows for the tempered chocolate to be continuously poured through the mold until the desired thickness of chocolate is reached.

Embodiments of the invention include spooning chocolate into the mold and then spreading the chocolate by, e.g., manually rotating the casing mold apparatus so that the chocolate disperses evenly across the surface. The casing mold may then be turned upside down and emptied of any excess chocolate, leaving a thin coating. The casing mold apparatus with a thin layer of chocolate may then be refrigerated to facilitate hardening of the chocolate, and then the chocolate may be once again spooned into the mold and spread by manually rotating the casing mold apparatus. Once complete, the casing mold apparatus with the second layer of chocolate may then be refrigerated again to facilitate hardening. This process may be repeated until the desired thickness is reached. Embodiments of the invention include interspersing other edible materials (including, e.g., cookies or cookie pieces, candies, coconut, crisped rice, sprinkles, fruits, nuts, edible printed paper, edible glitter, icing decorations, small molded chocolate pieces, sugar pieces, and/or any combination thereof) in between layers. Those skilled in the art will appreciate that the number of times the process is repeated will depend not only on the desired thickness, but also on the type or types of chocolate being employed, as well as a number of other factors.

In embodiments of the invention, it may be desirable to pour the tempered chocolate over the two half-cylindrical molds while they are separated. Then, at some time after the tempered chocolate is poured, the two half cylindrical molds may be joined and fastened. In embodiments of the invention, it may be desirable to pour the tempered chocolate once the two half-cylinders have been joined and fastened together to form the one-piece casing mold apparatus.

In embodiments of the invention, each half-cylindrical units may further comprise an inner molding piece that forms an inner circumference (in contrast to outer circumference of the open top). In embodiments of the invention, the inner circumference will be similar, but slightly less than, that of the outer circumference. This allows the tempered chocolate to be poured into the space between the inner circumference and the outer circumference. As described herein, in embodiments of the invention, it may be desirable to make the inner circumference and/or outer circumference expandable and/or adjustable to accommodate different bottle sizes and/or bottle types, as well as varying thicknesses of the chocolate casing.

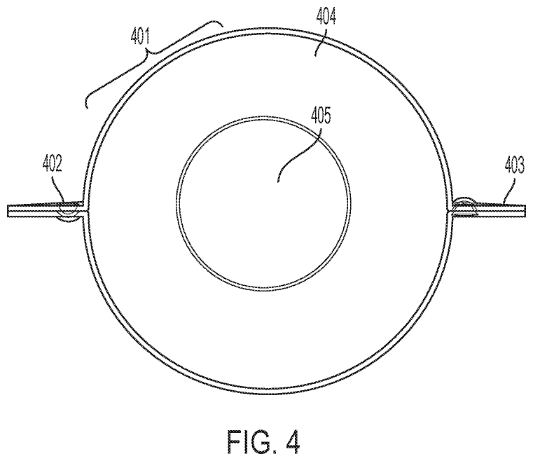

In embodiments of the invention, as shown and illustrated in FIG. 4, it may be desirable to prepare or use a solid cylindrical core to guide the tempered chocolate away from the center formed by the two secured half-cylindrical molds, and render the tempered chocolate more likely to adhere to the sides. FIG. 4 illustrates an embodiment of the invention in which the circumference of the one-piece casing mold apparatus (401) is prepared in accordance with the disclosures provided herein. Left wing (402) and right wing (403) can be seen extending from the cylindrical body of the one-piece casing mold apparatus (401). In between the joined half cylinders, is hollow space (404). In the particular embodiment shown in FIG. 4, the fastening means are complementary male/female bubbles which allow the first half-cylindrical unit to secure to the second half-cylindrical unit.

In an embodiment of the invention, solid cylindrical unit (405) is placed into hollow space (404). The solid cylindrical core may be made of any other suitable material for use with chocolate, such as, for example, silicone. In embodiments of the invention, the length of the solid cylindrical core (405) may be about the same as the length as the one-piece casing mold apparatus (401). However, it may be desirable or optimal in some cases to have a solid cylindrical core of a differing length than the length of the one-piece casing mold apparatus. While illustrated in the present example as a cylinder of a particular shape and dimension, those skilled in the art will appreciate that embodiments of the invention include a solid core in any shape or dimension fitting within the diameter of hollow space (404) and which facilitates the adherence of tempered chocolate to the casing mold apparatus.

The solid cylindrical core (405), once inserted into the one-piece casing mold apparatus (401), is used to form a pathway in which to pour the tempered chocolate. In an exemplary embodiment of the invention, solid cylindrical core (405) may measure about 3.25″ in diameter.

Those skilled in the art will appreciate that the solid cylindrical core may be a piece that is separate and distinct from the casing mold apparatus. In such an embodiment, the solid cylindrical core may simply be inserted, placed, and/or held in place while the tempered chocolate is being poured, spooned, or otherwise dispersed into the one-piece casing mold. Additionally or alternatively, the solid cylindrical piece may be incorporated as a structural component of the casing mold apparatus. Those skilled in the art will appreciate that this can be accomplished in a variety of different manners. In one exemplary embodiment, each of the two half-cylindrical molds may comprise a half solid cylindrical core extending from its half-base. In embodiments of the invention, the solid cylindrical core may have outwardly extending arms which affix and/or attach to the interior of the casing mold apparatus in a manner that does not prevent chocolate from being dispersed to that part of the casing mold apparatus.

Once the tempered chocolate has been poured into the casing mold apparatus and the desired thickness has been achieved, it may cool and harden according to methods that are known or conventional in the art. After cooling and hardening, the fastening means may be removed and/or disengaged from the two half-cylindrical molds, leaving a one-piece cylindrical chocolate bottle casing.

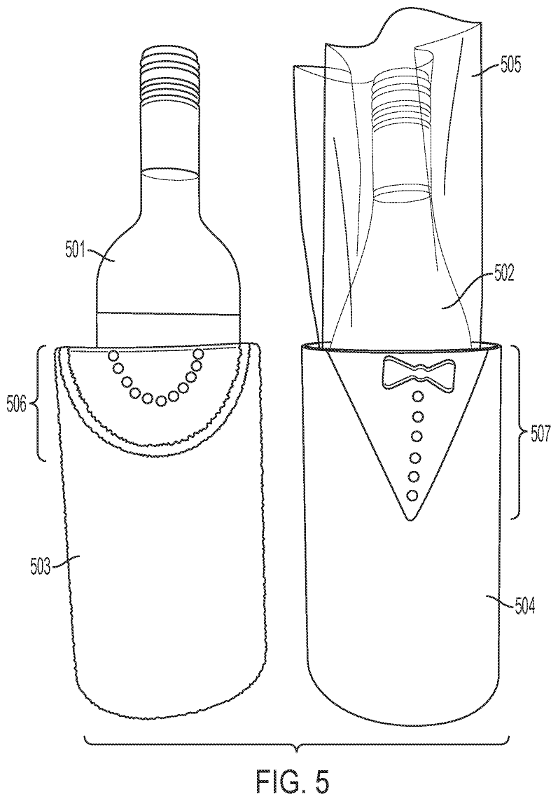

FIG. 5 illustrates two wine bottles (501, 502) with chocolate casings (503, 504) prepared in accordance with the present invention. In practice, it may be necessary or desirable to include a food-safe barrier layer, using, for example, plastic wrap (505) or other material known in the art, between the wine bottle and chocolate casing prior to insertion of the bottle into the chocolate casing.

Once prepared, the chocolate bottle casings (503, 504) may be decorated with any combination of a design, edible materials, text, and/or any other manner of customization known in the art. In FIG. 5, chocolate casings (503, 504) are customized with an exemplary bride (506) and groom (507) designs, respectively. Those skilled in the art will appreciate that color can be added to the customization by utilizing different types of chocolate in layers the mold. For example, layering milk chocolate over white chocolate in a particular arrangement allows for the contrasting areas between chocolate casings (503, 504) and their respective bride (506) and groom (507) designs. In embodiments of the invention, the chocolate bottle casing may be customized to include a personalized message to the recipient. Additionally or alternatively, the chocolate bottle casing may be decorated with cookies or cookie pieces, candies, coconut, crisped rice, sprinkles, fruits, nuts, edible printed paper, edible glitter, icing decorations, small molded chocolate pieces, sugar pieces, and/or any other similar or suitable ingredients. In embodiments of the invention, melted chocolate may be piped onto the chocolate casing in an icing bag in order to provide the “glue” to affix any such decorations to the chocolate casing. However, decorations may be added to the chocolate casing in any manner known or customary in the art. Additionally or alternatively, the one-piece cylindrical chocolate bottle casing may be decorated in any manner that is known or customary in the art.

In embodiments of the invention, a chocolate casing may be prepared for additional portions (e.g., the neck) of a bottle. This may be accomplished by tempering chocolate to the appropriate temperature and pouring it into either a commercially available mold or into a custom mold of the type described herein. Once cooled, the chocolate casing may then be removed from the mold and added to the neck of the bottle. Those skilled in the art will appreciate that, in embodiments of the invention, the chocolate casing for a bottle neck may be attached or affixed with a chocolate bottle casing for the bottle body prepared and described in the present invention in such a manner as to appear seamless (e.g., by allowing the bottle neck casing to cool and harden in such a manner that the bottle neck is joined to the chocolate casing for the bottle body). In embodiments of the invention, each piece of the two-piece cylindrical mold described herein may further comprise a half-neck to enclose the bottle neck or part of the bottle neck.

Additionally or alternatively, in some embodiments of the invention, it may be desirable to prepare a chocolate casing for the bottom of the bottle separately. In this exemplary embodiment, the two half-cylindrical units do not include a base portion, and a third piece forms the mold for the bottom portion of the bottle. The base mold may be affixed to the two half-cylindrical units in any manner known in the art or described herein, and at any time prior to or after the pouring of the chocolate. In embodiments of the present invention, the base is simply not used and the chocolate bottle casing does not include a chocolate base.

As described herein, the chocolate casing apparatus of the present invention may be designed to prepare chocolate bottle casings for bottles of varying sizes. Accordingly, embodiments of the invention may allow for different size molds depending on the size of the bottle. For example, and without limitation, a mini-bottle mold may comprise a one piece mold, while a large or oversize bottle mold may comprise a three piece mold.

In embodiments of the invention, a casing is prepared from a three-piece mold (two-piece mold for the casing of the body of the bottle, without a base, and one piece mold for the base). The casing is prepared in accordance with the present disclosure for a mini-bottle of liquor, and may be inverted and used as a glass (e.g., a shot glass) for drinking the contents of the mini-bottle. Those skilled in the art will appreciate that this may also be accomplished with a two piece mold of the type shown and described herein.

It is to be understood that the detailed description and specific examples, while indicating preferred embodiments of the present disclosure, are given by way of illustration and not limitation. Many changes and modifications within the scope of the present disclosure may be made without departing from the spirit thereof, and the disclosure includes all such modifications.

1. A casing mold apparatus for preparing a bottle casing, the apparatus comprising:
a first half-cylindrical mold and a second half cylindrical mold, each comprising a half-base, half open top, a left wing, and a right wing;
wherein the first half-cylindrical mold and a second half cylindrical mold are joined together with a fastening means.

2. The casing mold apparatus of claim 1, wherein the casing mold apparatus is used to prepare a chocolate bottle casing.

3. The casing mold apparatus of claim 2, wherein the casing mold apparatus is used to prepare a chocolate bottle casing for use with a wine bottle.

4. The casing mold apparatus of claim 2, wherein the chocolate is tempered chocolate comprising one or more of the following: milk chocolate, dark chocolate, and white chocolate.

5. The method of claim 4, wherein the chocolate further comprises one or more of the following: cookies or cookie pieces, candies, coconut, crisped rice, sprinkles, fruits, nuts, edible printed paper, edible glitter, icing decorations, small molded chocolate pieces, or sugar pieces.

6. The casing mold apparatus of claim 2, wherein the chocolate bottle casing is customized using edible materials.

7. The casing mold apparatus of claim 2, wherein the chocolate bottle casing is about 0.25 inches thick.

8. The casing mold apparatus of claim 2, wherein the chocolate bottle casing is about 0.5 inches thick.

9. The casing mold apparatus of claim 2, wherein the chocolate bottle casing is about 0.75 inches thick.

10. The casing mold apparatus of claim 1, wherein the fastening means comprises one or more clips.

11. The casing mold apparatus of claim 1, wherein the two half-cylindrical molds are made of at least one of the following: plastic or silicone.

12. The casing mold apparatus of claim 1, further comprising a solid cylindrical core between the first half-cylindrical mold and a second half cylindrical mold.

13. The casing mold apparatus of claim 12, wherein the solid cylindrical core is permanently affixed to the half-base of one or both of the first and a second half cylindrical molds.

14. A method for manufacturing a chocolate bottle casing, the method comprising:
securing two half-cylindrical molds to each other to form a casing mold apparatus;
causing chocolate to be dispersed into the casing mold apparatus;
separating the two half-cylindrical molds; and
extracting the chocolate bottle casing.

15. The method of claim 14, further comprising inserting a bottle into the extracted chocolate bottle casing.

16. The method of claim 15, wherein the bottle is a wine bottle.

17. The method of claim 14, further comprising customizing the exterior of the chocolate bottle casing.

18. The method of claim 17, wherein the exterior of the chocolate bottle casing is customized using edible materials.

19. The method of claim 17, wherein the exterior of the chocolate bottle casing is customized with text.

20. The method of claim 14, further comprising inserting a solid cylindrical core into the casing mold apparatus prior to pouring the chocolate.
